(19) United States
(12) Patent Application Publication
(10) Pub. No.: US 2009/0010576 A1
(43) Pub. Date: Jan. 8, 2009

(54) TUBULAR POUCH HAVING A SEALED-IN STANDING BOTTOM OR STAND BASE BOTTOM AND LID/SHOULDER PART, AND ASSOCIATED BASE, LID/SHOULDER PART AND METHOD FOR THE PRODUCTION THEREOF

(76) Inventor: Andreas Michalsky, Memmingen (DE)

Correspondence Address: Husch Blackwell Sanders, LLP;Welsh & Katz, 120 S RIVERSIDE PLAZA, 22ND FLOOR, CHICAGO, IL, 60606, US

(21) Appl. No.: 11/547,212

(22) PCT Filed: Feb. 24, 2005
(86) PCT No.: PCT/EP2005/001961

§ 371 Date: Sep. 23, 2008

(30) Foreign Application Priority Data
Mar. 31, 2004 (DE) 10 2004 015 959.9
May 6, 2004 (DE) 10 2004 022 375.0

(51) Int. Cl. B65D 30/16; B31B 49/00

(52) U.S. Cl. 383/104; 493/267

(57) ABSTRACT

The invention relates to a tubular pouch having a tubular pouch body and, sealed thereto, especially sealed therein, a base, preferably a standing or stand base, and a lid and/or shoulder part, the base and the lid and/or shoulder part having a rigid predetermined shape with sealable borders, being thermoformed and having at least one barrier layer. The invention further relates to a method of producing such a tubular pouch.

The invention relates to a tubular pouch, to a standing or stand base and to a lid and/or shoulder part and to a method for the production thereof, in accordance with the preambles of patent claims 1 to 3 and 12.

Tubular pouches having a sealed-in standing or stand base and lid have been known for a relatively long time and are used for filling, storing and transporting materials that are solid, liquid or in paste form.

However, disadvantages of those known tubular pouches lie in their inadequate standing stability and also in the fact that they are suitable only for materials which are not capable of permeating or diffusing through the materials forming the tubular pouch or which behave inertly with respect to substances diffusing into the tubular pouch.

The first problem, namely the inadequate standing stability of customary tubular pouches, generally results from their standing surface having a more or unless unstable, usually oval, shape so that, along the longitudinal side of the oval shape, and because of the unstable mode of construction of their standing surface, the tubular pouches have an increased tendency to topple over.

The second problem is due to the fact that hitherto customary tubular pouches have merely inadequate barrier properties, especially with respect to gases entering and/or exiting, because generally it is only the tubular pouch body that is provided with a barrier layer. This does not usually apply, however, in the case of the base of the tubular pouches or, to an equally small degree, in the case of their upper termination such as the lid and/or, where present, shoulder part. Both the base and also components terminating the tubular pouch at the top are usually produced from a conventional plastics material which does not have any barrier properties. To that extent, the possibility exists at those surfaces of the tubular pouch for undesirable exchange of substances with the environment, which is caused by substances passing through the tubular pouch wall. It should be noted that, in the context of the present invention, the wall is understood to be not only the side wall but also the upper and lower terminations of the tubular pouch.

The problem of the invention is to provide a solution to the above-mentioned disadvantages of the prior art in economical and simple manner and to make available a tubular pouch and an associated standing or stand base and upper termination to the tubular pouch which, in addition to providing the tubular pouch with a high degree of security in standing, also provides it with a high degree of sealing with respect to undesirable permeation and/or diffusion of substances through the tubular pouch wall.

The problem is solved by a tubular pouch according to patent claim 1, a standing or stand base according to patent claim 2, a lid and/or shoulder part according to patent claim 3, and also by a method of producing a tubular pouch according to patent claim 12.

The problem is especially solved by a tubular pouch having a tubular pouch body and, sealed thereto, a lid and/or shoulder part and a base, especially a standing or stand base, wherein the base and/or lid and/or shoulder part have a rigid predetermined shape with sealable borders, are thermoformed and have at least one barrier layer.

A significant feature of this solution according to the invention lies in the fact that the base is formed in a manner which optimises it as a standing or stand base. In accordance with the invention this is ensured by means of the fact that the base is of a predetermined shape provided with a certain rigidity, with borders being provided by means of which the standing or stand base can be sealed in the tubular pouch body.

A further substantial advantage of the invention lies in the fact that the base and also the lid and/or shoulder part have at least one barrier layer by means of which it is ensured that undesirable substance transfer through the tubular pouch wall, in this case explicitly the base and an upper termination of the tubular pouch, does not take place. Suitable barrier materials are especially ethyl vinyl alcohol (EVOH), silicon dioxide (SiO₂) and also vapour-deposited or foil-form metals such as, especially, aluminium. Those barrier materials can be used on their own or in combination, especially in the form of a laminate. Those barrier materials are preferably arranged between sealable layers of the laminate.

In order to provide the standing or stand base according to the invention and also, if desired, the lid and/or shoulder part with sufficient rigidity, it is made from a material having a thickness in the range from 50 μm to 500 μm, preferably from 100 μm to 400 μm and especially from 150 μm to 350 μm. This material is subjected to a thermoforming procedure, it being possible in efficient manner for a plurality of standing or stand bases to be simultaneously produced from one film blank. The same applies to lids and shoulder parts.

Preferably, the shape of the standing base and of the lid and/or shoulder part is so selected that the cut edges produced on separation of the individual parts do not come into contact with the contents of the tubular pouch once they have been inserted in the tubular pouch body, so that there is no fear of a reaction taking place between the contents of the tubular pouch and the barrier material. This is ensured, for example, by means of the fact that the cut edges of the parts point towards the outside.

A further possibility for avoiding such contact is for the base part and also the lid and/or shoulder part not to be inserted into the tubular pouch body but rather vice versa.

A substantial advantage of using a thermoforming method in accordance with the invention for making the standing or stand bases and lid and/or shoulder parts lies in the fact that very many tubular pouch termination parts can be produced simultaneously by this method so that the outlay associated with producing those parts is minimised and economical mass production is possible. In addition it is possible, by means of the thermoforming method, to form stand bases and lid and/or shoulder parts which are made of a laminate and have one or more barrier layers.

In accordance with the invention, the base is made from substantially the same material as the tubular pouch body itself, although the base, or the material used to produce it, can be thicker and consequently more rigid than the tubular pouch body itself, or the material therefor.

The tubular pouch body itself is either produced, using a lap seal, from a film blank or from an endless film or is extruded in tube form. Formation of the tubular pouch body seam with a lap seal or extrusion of the tubular pouch body provides for an approximately round shape of the tubular pouch body, which in combination with the standing or stand base according to the invention results in a high degree of security in standing.

Both a tubular pouch body produced with a lap seal and also an extruded, especially co-extruded, body have in each case one or more barrier layers. Accordingly, it is advantageously ensured that undesirable transfer of material through the tubular pouch wall does not take place.

Of course, this applies likewise to the lid and/or an optionally provided shoulder part of the tubular pouch, which in like manner to the tubular pouch base can also be thermoformed and also, in the case of the shoulder part, has one or more barrier layers. This also applies to the associated lid and/or shoulder part.

In accordance with one embodiment, the lid part additionally has at least one fitting arrangement for a pourer and/or a closure at an opening provided therefor in the lid part. Preferably, for the purpose, a hole having a border crimped towards the inside is stamped out in the lid. A pourer or a closure can be snap-fitted onto that crimped border, which can be carried out after the tubular pouch has been filled through the hole. Accordingly, it is advantageously possible to dispense with more costly sealing, although this is of course additionally or alternatively possible.

Accordingly, filling and subsequent closure of the tubular pouch can be carried out immediately one after the other. Accordingly, the hygienic conditions can advantageously be optimised during manufacture and filling.

A further substantial advantage according to the invention lies in the fact that the tubular pouch as a whole, and also each of its components, especially the base, shoulder part and lid and also the tubular pouch body, can be sterilised. This means, in other words, that the materials used are inert with respect to sterilisation methods customarily used for tubular pouches. As a result it is possible to use customary sterilisation methods such as steam sterilisation, sterilisation with ethylene oxide and like suitable methods.

The problem of the invention is furthermore solved by a method of producing a tubular pouch having a tubular pouch body and, sealed thereto, especially sealed therein, a base, especially a standing or stand base, and a lid and/or shoulder part, wherein a base, consisting of substantially the same material as the tubular pouch body and having a rigid predetermined shape, and also the lid and/or shoulder part are produced by means of thermoforming and, at sealable borders of the base in a base region of the tubular pouch body and at sealable borders of the lid and/or shoulder part in a top region of the tubular pouch body, respectively, are tightly sealed to sealable borders of the tubular pouch body.

Further embodiments of the invention are found in the subordinate claims.

The invention will be described hereinbelow with reference to an exemplary embodiment which will be explained in greater detail with reference to a drawing, in which:

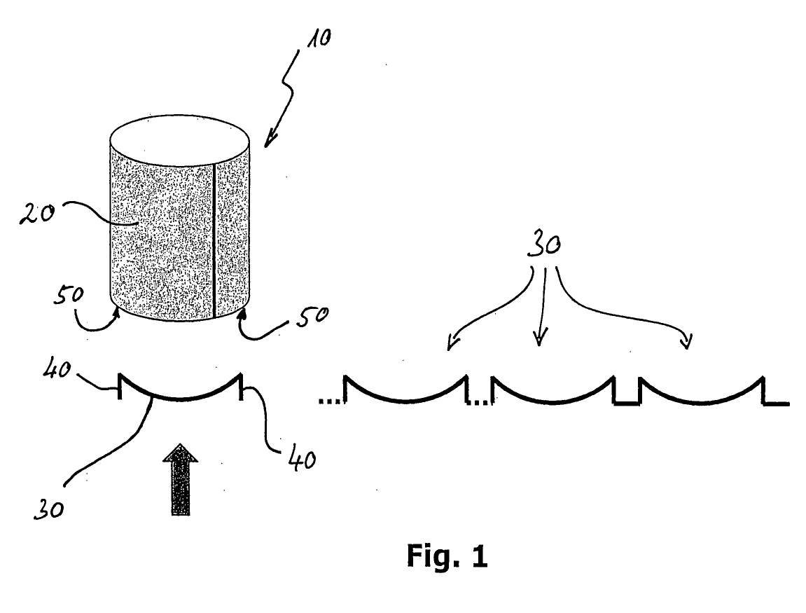

FIG. 1 shows, in diagrammatic form, the production method for a tubular pouch according to the invention using the example of a standing or stand base.

In the description that follows, the same reference numerals are used for parts that are the same or that act in the same way.

FIG. 1 shows, from right to left, in a diagrammatic sequence, the production of a tubular pouch 10 according to the invention using the example of a standing or stand base, which is likewise indicated in diagrammatic manner.

First, a base 30 is produced from a film blank by means of thermoforming. In the course of that thermoforming method, a plurality of bases, which to begin with are still connected to one another, are produced. Later on in the sequence, the bases 30 are separated from one another. This is indicated in FIG. 1 by the broken line.

Then, in each case, a separated base 30 is inserted into an associated tubular pouch body 20 in the direction of the broad arrow. For the purpose, the base 30 is held, for example, by means of a suction cup or other holding device. An alternative to insertion of the base 30 into the tubular pouch body 20 also consists of lowering the tubular pouch body 20 onto a base 30 standing on a substrate. The base 30 is preferably round in shape. It can, however, also have corners, for example in the form of a square or a triangle, pentagon or hexagon. After the base 30 has been inserted into the tubular pouch body 20, a border 40 of the base 30 is sealed to the inner border 50 of the tubular pouch body. For sealing there is preferably used thermal energy and/or ultrasound.

In corresponding manner, a lid element, for example in the form of a shoulder part, can be attached to the tubular pouch. At this point it should be noted that it is likewise possible for the tubular pouch to be inserted into the base. For the purpose, the base is rotated vertically through 180° and is preferably so manufactured that the resulting inner edge bounding the border 40 of the base 30 has substantially the same diameter as the tubular pouch body 20. In that case, the inside of the border 40 of the base 30 would be sealed to the outside of the border 50 of the tubular pouch body 20.

At this point it should be stated that all above-described parts, considered on their own and in any combination, especially the details shown in the drawings, are claimed as being important for the invention. The skilled person will be familiar with modifications thereof.

### LIST OF REFERENCE NUMERALS

10 tubular pouch
20 tubular pouch body
30 base
40 border of base
50 border of tubular pouch body

1-12. (canceled)

13. A tubular pouch having a tubular pouch body and, sealed thereto, a part selected from the group consisting of a lid, a shoulder part, and a lid and a shoulder part, and a part selected from the group consisting of a base, a standing base, and a stand base, wherein a part selected from the group consisting of the base, the lid, the shoulder part, the base and the lid, the base and the shoulder part, the lid and the shoulder part, and the base, the lid and the shoulder part have a rigid predetermined shape with sealable borders, are thermoformed and have at least one barrier layer.

14. A base for a tubular pouch having a tubular pouch body and, sealed thereto, a part selected from the group consisting of a lid, a shoulder part, and a lid and a shoulder part, and a part selected from the group consisting of a base, a standing base, and a stand base, said base having a rigid 3-dimensional predetermined shape with sealable borders, being thermoformed and having at least one barrier layer.

15. A lid or shoulder part for a tubular pouch having a tubular pouch body and, sealed thereto, a part selected from the group consisting of a lid, a shoulder part, and a lid and a shoulder part, and a part selected from the group consisting of a base, a standing base, and a stand base, said lid and/or shoulder part having a rigid 3-dimensional predetermined shape with sealable borders, being thermoformed and having at least one barrier layer.

16. A tubular pouch according to claim 13, wherein a part selected from the group consisting of the base, the lid, the shoulder part, the base and the lid, the base and the shoulder part, the lid and the shoulder part, and the base, the lid and the shoulder part has a protuberant, preferably outwardly protuberant, central region having a peripheral border extending in the direction of the protuberance, which border serves as a sealing border.

17. A tubular pouch according to claim 13, wherein a part selected from the group consisting of the base, the lid, the shoulder part, the base and the lid, the base and the shoulder part, the lid and the shoulder part, and the base, the lid and the shoulder part is made from a relatively rigid material.

18. A tubular pouch according to claim 13, wherein a part selected from the group consisting of the base, the lid, the shoulder part, the base and the lid, the base and the shoulder part, the lid and the shoulder part, and the base, the lid and the shoulder part is made from substantially the same material as the tubular pouch body.

19. A tubular pouch according to claim 13, wherein a part selected from the group consisting of the base, the lid, the shoulder part, the base and the lid, the base and the shoulder part, the lid and the shoulder part, and the base, the lid and the shoulder part is made from an aluminum laminate.

20. A tubular pouch according to claim 13, wherein a part selected from the group consisting of the base, the lid, the shoulder part, the base and the lid, the base and the shoulder part, the lid and the shoulder part, and the base, the lid and the shoulder part has a thickness in the range from 50 μm to 500 μm, preferably from 100 μm to 400 μm and especially from 150 μm to 350 μm.

21. A tubular pouch according to claim 13, wherein the tubular pouch body, the base and the lid and shoulder part are sterilisable.

22. A tubular pouch according to claim 13, wherein the lid part has at least one fitting arrangement for a pourer and/or a closure at a preferably stamped-out hole.

23. A tubular pouch according to claim 13, wherein the pourer and/or closure is attached seal-free.

24. A method of producing a tubular pouch having a tubular pouch body and, sealed thereto, a part selected from the group consisting of a base, a standing base, and a stand base, and a part selected from the group consisting of a lid, a shoulder part and a lid and a shoulder part, wherein a base, consisting of substantially the same material as the tubular pouch body and having a rigid 3-dimensional predetermined shape, and also a part selected from the group consisting of the lid, the shoulder part, and the lid and the shoulder part is produced by means of thermoforming and, at sealable borders of the base in a base region of the tubular pouch body and at sealable borders of a part selected from the group consisting of the lid, the shoulder part, and the lid and the shoulder part in a top region of the tubular pouch body, respectively, are tightly sealed to sealable borders of the tubular pouch body.
